(19) United States
(12) Patent Application Publication
(10) Pub. No.: US 2013/0191641 A1
(43) Pub. Date: Jul. 25, 2013

(54) CAPTCHA (COMPLETELY AUTOMATED PUBLIC TEST TO TELL COMPUTERS AND HUMANS APART) DATA GENERATION METHODS AND RELATED DATA MANAGEMENT SYSTEMS AND COMPUTER PROGRAM PRODUCTS THEREOF

(71) Applicant: Helen Pai, Mountain View, CA (US)

(72) Inventor: Helen Pai, Mountain View, CA (US)

(73) Assignee: F2WARE INC., Mountain View, CA (US)

(21) Appl. No.: 13/353,588

(22) Filed: Jan. 19, 2012

(51) Int. Cl. G06F 21/24; H04L 9/32

(52) U.S. Cl. 713/176; 726/29; 713/168

(57) ABSTRACT

CAPTCHA (Completely Automated Public Test to tell Computers and Humans Apart) data generation methods for use in an electronic device and related management systems are provided. First, the electronic device determines a first data set according to at least one first data corresponding to an operation to be performed, wherein the first data represents sensitive data corresponding to the operation. Then, the electronic device generates a group of CAPTCHA data corresponding to the first data set according to the first data. The electronic device may be a server or a client. When the electronic device is the client, the client obtains at least one generation module from the server to determine the first data set, and generate the CAPTCHA data. In some embodiments, during a data transmission procedure, the client performs the operation with the server using the CAPTCHA data.

### BACKGROUND OF THE INVENTION

1. Field of the Invention

The disclosure relates generally to data processing methods and related data management systems, and, more particularly to data generation methods for generating data based on CAPTCHA (Completely Automated Public Test to tell Computers and Humans Apart) data and related data management systems and application management methods that provide enhanced data protection for transmitted data.

2. Description of the Related Art

With the increasing growth and development of network applications, the opportunity for users to access information through a network has been significantly increased. A user may utilize various electronic devices, such as computer systems, portable devices and so on, to perform a large number of services and applications through the network. In some network services, a user may need to perform a registration procedure for a specific service or perform a confirmation procedure regarding some information. In the registration or the confirmation process, the user has to inspect related information provided by the server that provides the specific service and inputs related data based on the provided information for the registration or confirmation procedure.

Conventionally, information transmitted between a client and a server is done by using computer-based texts, which may easily be revised by malicious programs, e.g. viruses or wooden horse programs. Even if a virtual keyboard is utilized for inputting data, the data inputted at the client side is still transmitted to the server by using computer-based texts. For example, input of the current transaction data may be made by a keyboard or a virtual keyboard that appears on the computer screen. The data that is selected at the client side and transmitted to the server is transmitted by using computer-based texts for recognition of the transaction content.

To prevent personal data or content of operations from being tampered with or stolen by unauthorized users, enhancements in security strategies for data transmission between the server and the client are required. It is therefore desirable to provide a method and system capable of ensuring that data transmitted between the server and the client are correct and are being protected when any operation is performed between a server and a client. In addition, some of current techniques may cheat the server by sniffing and simulating the user input behavior at the client side so as to complete a data recovery operation, thus resulting in high risk for data transmission that requires high security.

### BRIEF SUMMARY OF THE INVENTION

Data generation methods and data management systems and application management methods thereof are provided.

In one exemplary embodiment, a data generation method for CAPTCHA (Completely Automated Public Test to tell Computers and Humans Apart) data generation for a server is provided. First, the electronic device determines a first data set according to at least one first data corresponding to an operation to be performed, wherein the first data represents sensitive data corresponding to the operation. Then, the electronic device generates a group of CAPTCHA data corresponding to the first data set according to the first data. The electronic device is a server or a client. When the electronic device is the client, the client obtains at least one generation module from the server to determine the first data set, and generate the CAPTCHA data.

In another exemplary embodiment, a data management system for CAPTCHA (Completely Automated Public Test to tell Computers and Humans Apart) data is provided. The system at least comprises an electronic device determining a first data set according to at least one first data corresponding to an operation, and generating a group of CAPTCHA data corresponding to the first data set according to the first data, wherein the first data represents sensitive data corresponding to the operation. The electronic device is a server or a client. When the electronic device is the client, the client obtains at least one generation module from the server to determine the first data set, and generate the CAPTCHA data.

In another exemplary embodiment, a non-transitory machine-readable storage medium comprising a computer program, which, when executed, causes a device to perform a data generation method for CAPTCHA (Completely Automated Public Test to tell Computers and Humans Apart) data is provided. The computer program comprises a first program code for determining a first data set according to at least one first data corresponding to an operation, wherein the first data represents sensitive data corresponding to the operation, a second program code for generating a group of CAPTCHA data corresponding to the first data set according to the first data, and a third program code for hiding corresponding encrypted data into each CAPTCHA data in the group of CAPTCHA data, wherein the encrypted data includes information corresponding to the operation.

In yet another exemplary embodiment, an application management method for CAPTCHA (Completely Automated Public Test to tell Computers and Humans Apart) data is provided. First, a server or a client determines a first data set according to at least one first data corresponding to an operation and generating a group of CAPTCHA data corresponding to the first data set according to the first data, wherein the first data represents sensitive data corresponding to the operation. Then, during a data transmission procedure, the client performs the operation with the server using the CAPTCHA data, and before the data transmission procedure is complete, the server indicates the client to perform a specific operation by using a physical device and the server further validates that the operation has been completed and terminate data transmission procedure when detecting that the client performs the specific operation by using the physical device.

In some embodiments, when the electronic device is the server, the server further transmits the group of CAPTCHA data to the client and the client further performs the operation with the server using the group of CAPTCHA data.

In some embodiments, when the electronic device is the client, the client directly transmits the group of CAPTCHA data or summary information corresponding to the group of CAPTCHA data to the server to perform the operation using the group of CAPTCHA data.

### BRIEF DESCRIPTION OF THE DRAWINGS

The invention will become fully understood by referring to the following detailed description with reference to the accompanying drawings, wherein:

FIG. 1 is a schematic diagram illustrating an embodiment of a data management system of the invention;

FIGS. 2A, 2B and 2C are schematic diagrams illustrating embodiments of CAPTCHA data of the invention;

FIG. 3 is a schematic diagram illustrating an embodiment of CAPTCHA data with encrypted data of the invention;

FIG. 4 is a flowchart of an embodiment of a data generation method for CAPTCHA data of the invention;

FIG. 5 is a schematic diagram illustrating another embodiment of a data management system of the invention;

FIG. 6 is a flowchart of another embodiment of a data generation method for CAPTCHA data of the invention; and

FIG. 7 is a flowchart of an embodiment of an application management method for CAPTCHA data of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Embodiments of the invention provide data generation methods and related data management systems for performing an operation based on CAPTCHA (Completely Automated Public Test to tell Computers and Humans Apart) data for use in an electronic device such as a server and/or a client, wherein the electronic device may determine a first data set according to one or more sensitive or important data corresponding to an operation requested by a user at a client side. Then, the electronic device generates a group of CAPTCHA data corresponding to the first data set according to the sensitive or important data. At the same time, a specific encrypted data (such as a watermark) may be added to every CAPTCHA data generated. Thereafter, the group of CAPTCHA data with encrypted data may be used to perform an operation with the client and verify data transmitted between the client and the server. Hence preventing the data from being revised during the transmission process.

In the embodiments, a data generation method is provided to use the CAPTCHA data generated (e.g. images or pictures) for an operation (e.g. a transaction process). First, a server generates images (CAPTCHA data) that can be recognized by human users or computers, wherein the images generated may be in different arrangements or combinations according to contents of different transactions. When the images are generated by the server, the server may transmit the images to a client via a transmission medium. The client may use the images as an input for transaction data so that transaction processes can be performed, and send the images to a server via a transmission medium. Finally, the server may verify content of the transaction according to the image. When the images are generated by the client, the client may directly use the images as an input for transaction data so that transaction processes can be performed, and send the images to the server via a transmission medium. Finally, the server may verify content of the transaction according to the image.

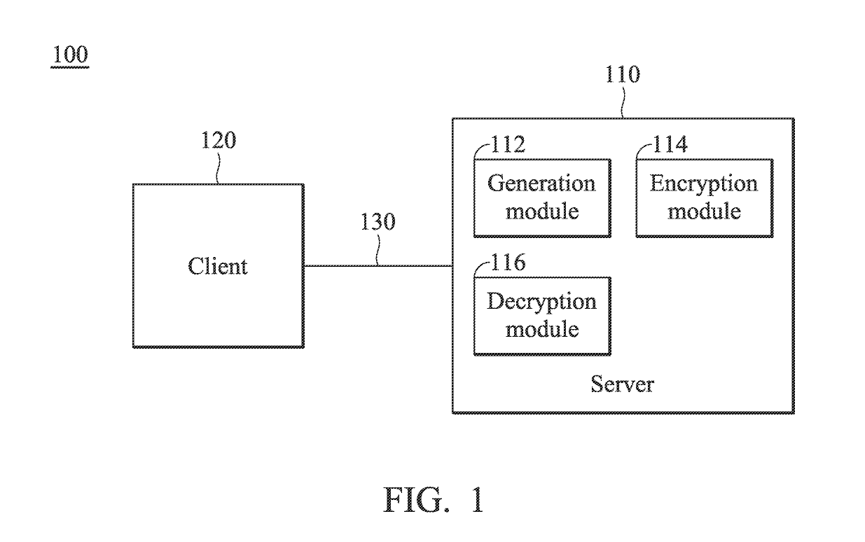

FIG. 1 is a schematic diagram illustrating an embodiment of a data management system of the invention. The data management system 100 at least comprises a server 110 and a client 120, wherein the server 110 may transmit data to the client 120 via a transmission medium, such as a network 130, for performing an operation between the server 110 and the client 120. The transmission medium may comprise, for example, and not limited to, the network 130, which may comprise wired or wireless networks, such as the INTERNET, but it is not limited thereto. In this embodiment, an operation may comprise one or more operational steps and the operational steps follow a predetermined execution flow. When the operation is performed, all of the operational steps corresponding thereto should be sequentially performed according to the predetermined execution flow.

The server 110 further comprises a generation module 112, an encryption module 114, and a decryption module 116. The generation module 112 is configured to determine a first data set according to a first data. Furthermore, the generation module 112 may determine a first data set according to one or more first data corresponding to an operation to be performed, wherein, the first data may be sensitive data corresponding to the operation, such as a user's personal identity information, account number, transaction amount, address and so on. The first data may require special processing since it may have an effect on the outcome of the operation. A first data set may comprise all possible information corresponding to a first data. For example, suppose the first data is a numeric data, the corresponding first data set may be the numbers 0-9.

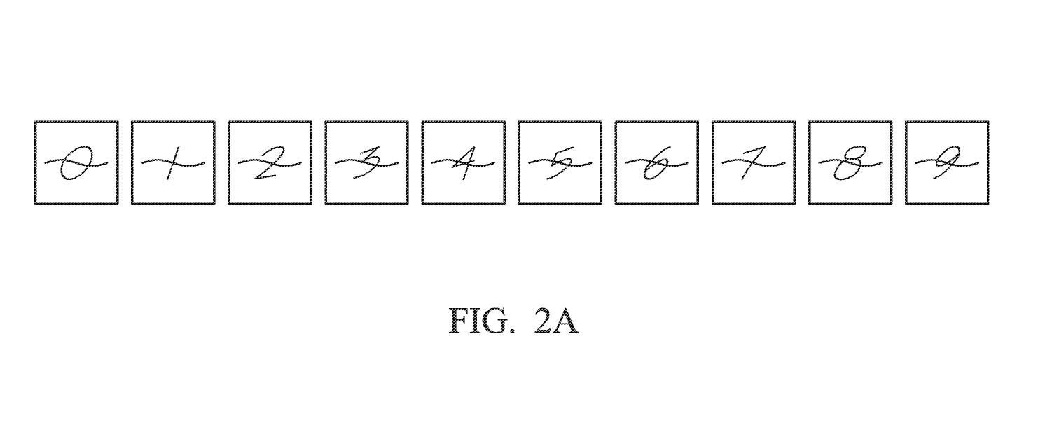

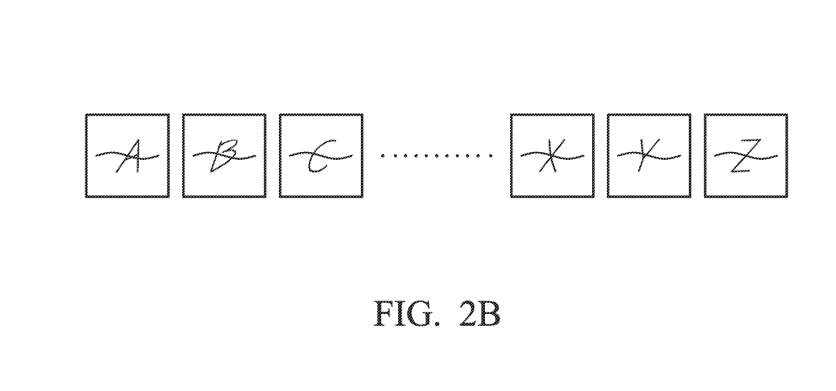

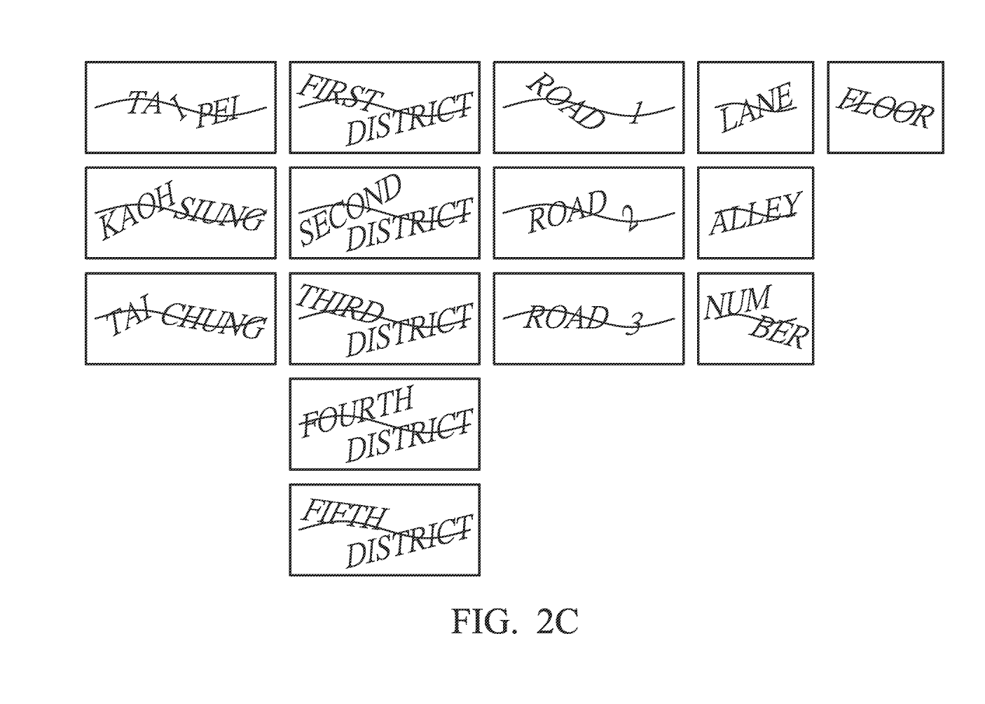

Then, according to a property of the first data, the generation module 112 may generate a group of CAPTCHA data corresponding to the first data set. In order to prevent input of a large number of malicious data and repeated data from automatic programs or computers, the CAPTCHA technique can be utilized to distinguish between a computer and a human user by identifying whether an input is made by a human user or generated by a computer automatically. Generally, the CAPTCHA process usually involves one computer asking a user to input letters or digits shown in a distorted image that other computers or automtic programs are supposedly unable to mimic, such as an image with skewed and/or deformed letters or digits or an image with letters or digits including a line added thereon, so as to distinguish between whether the input (response) is made by a human user or by a computer. It is to be noted that, in this embodiment, the concept of CAPTCHA is applied to provide CAPTCHA data corresponding to data required by the operation. The first data set may be divided into multiple data segments according to a property of the first data. For example, when the first data is a numeric data composed of one or more numbers, each data segment may be one or more numbers. Therefore, according to a property of numeric data, the generation module 112 may generate a group of CAPTCHA data comprising numbers 0-9 (as shown in FIG. 2A). In another embodiment, when the first data is a character data which is composed of one or more characters, each data segment may be one or more characters. Therefore, according to a property of a character data, the generation module 112 may generate a group of CAPTCHA data comprising characters A-Z (as shown in FIG. 2B). In another embodiment, assuming the first data is an address data, the address data may comprise words or character data (such as city, district, road or street, lane, alley and so on). Therefore, according to a property of the address data, the generation module 112 may generate a group of corresponding CAPTCHA data comprising one or more characters (as shown in FIG. 2C). Note that in the embodiments described at the above, the CAPTCHA data illustrated from FIG. 2A to FIG. 2C are images or pictures (image data). However, in some embodiments, the CAPTCHA data may be in the form of video data or audio data.

For example, but not limited to, in one embodiment, when the operation is a bank transfer operation for a net bank, the data required by the operation may comprise sensitive data such as an account number and an amount transferred. Thus, the generation module 112 may generate 10 CAPTCHA data corresponding to digits 0-9, respectively (as shown in FIG. 2A). In another embodiment, when the required account information of the operation comprises a combination of English characters and numbers, the generation module 112 may generate 38 CAPTCHA data corresponding to the English characters A-Z and the numbers or digits 0-9, respectively (as shown in FIG. 2A and FIG. 2B).

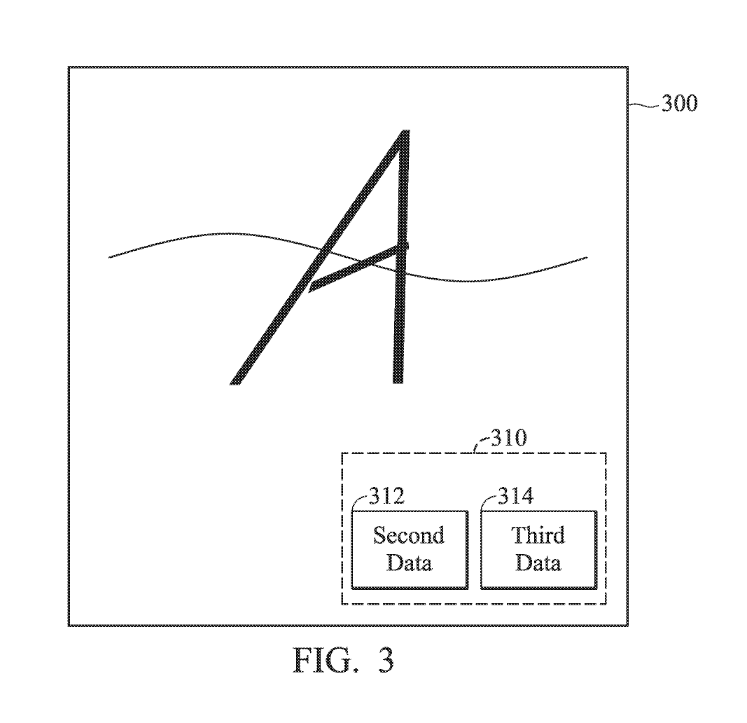

After the generation module 112 generates a group of CAPTCHA data corresponding to the first data set, the encryption module 114 may hide a corresponding encrypted data into each CAPTCHA data, wherein the encrypted data includes information corresponding to the operation, such as identification information of a user or information of an operational step. In some embodiments, the encrypted data may be a watermark, a digital signature, or a specific key generated by an algorithm. Please refer to FIG. 3, wherein FIG. 3 is a schematic diagram illustrating an embodiment of a CAPTCHA data with encrypted data of the invention. As shown in FIG. 3, the CAPTCHA data 300 comprises an encrypted data 310, and the encrypted data 310 is an unseen watermark. The encrypted data 310 further comprises a second data 312 and a third data 314. For example, the second data 312 may represent a corresponding operational step for the encrypted data 310, wherein an operation may comprise multiple operational steps. Namely, encrypted data 310 is generated during a corresponding operational step indicated by the second data 312. The third data 314 may represent identification information of a user of the client 120. Specifically, by inspecting the second data 312 and the third data 314, the step for which the encrypted data 310 is generated and user may be known, and thereby, the user identity and information may be verified.

The CAPTCHA data with encrypted data hidden in it is transmitted to the client 120, and the client 120 may use the CAPTCHA data to perform the operation with the server 110. During the operation, the client 120 may transmit chosen CAPTCHA data to the server 110 for verification.

After that, for example, an operational step may be performed to input the amount of money, wherein the user may input digits of the amount of money by clicking and selecting the CAPTCHA data corresponding to the digit to be inputted. When the user inputs digits of the amount of money, the client 120 may transmit the corresponding CAPTCHA data or its summary information to the server 110 to verify whether the input data is correct and has been successfully transmitted to the server 110.

The decryption module 116 is configured to decrypt the CAPTCHA data with hidden encrypted data transmitted by the client 120. The decryption module 116 may decrypt the encrypted data (e.g. a watermark) from the CAPTCHA data transmitted by client 120, and determine whether the received data is the same as the data originally transmitted according to the content represented by the encrypted data. In some embodiments, the generation module 112 may generate summary information according to information corresponding to the operation. For example, the summary information may be a specific data structure which comprises, for example, the second data 312 and the third data 314 as described previously. In some embodiments, data transmitted by the client 120 may be the summary information corresponding to the CAPTCHA data. In this case, the decryption module 116 may decode and extract second data and third data from the summary information transmitted by client 120, and then determine whether the received data is the same as the data originally transmitted according to the content represented by the second data and the third data. The correctness of data transmitted between the server and the client is therefore ensured by the decryption module 116. Detailed methods for CAPTCHA data generation are described hereafter.

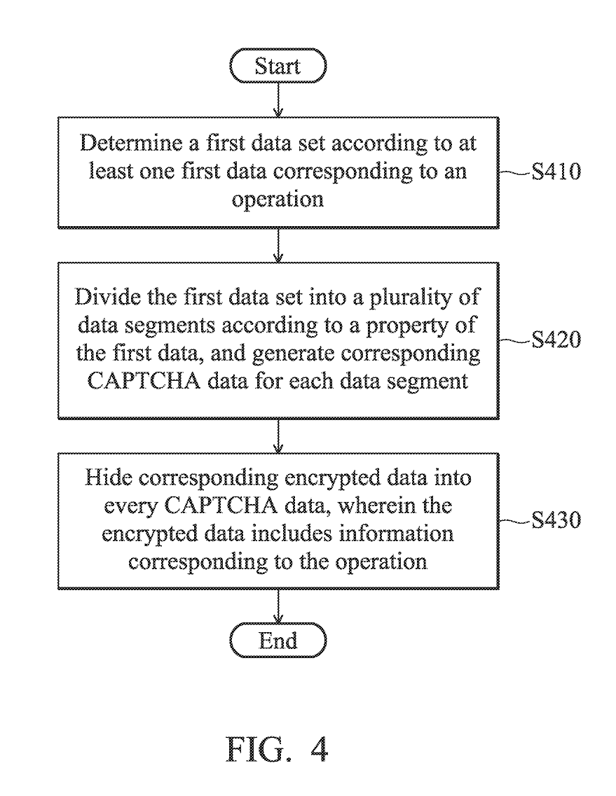

FIG. 4 is a flowchart of an embodiment of a data generation method of the invention. Please refer to FIGS. 1-4. The data generation method of the invention is suitable for use in the server 110 of the data generation system 100 for generating information required when performing an operation. The operation comprises plural operational steps with a fixed execution order. For example, an operation may comprise a first step and a second step, and the second step may be executed only after completion of the first step.

First, in step S410, the generation module 112 determines a first data set according to at least one first data corresponding to an operation. For example, when the first data comprises numeric data, the corresponding first data set may be the numbers 0-9. In another embodiment, when the first data comprises character data, the corresponding first data set may be a set of all possible characters (e.g. A-Z). Then, as shown in step S420, the generation module 112 divides the first data set into a plurality of data segments according to a property of the first data, and generates corresponding CAPTCHA data for each data segment. Similarly, when the first data comprises numeric data which is composed of one or more numbers, each data segment may be one or more numbers. When the first data comprises character data which is composed of one or more characters, each data segment may be one or more characters. For example, but not limited to, when the operation is a bank transfer operation for a net bank, the data required by the operation may comprise sensitive data such as the account number and the amount transferred, thus the generation module 112 may generate 10 CAPTCHA data corresponding to digits 0-9, respectively (as shown in FIG. 2A). In another embodiment, if the account number comprises a combination of the letters of the alphabet and digits, the server 110 may generate 36 CAPTCHA data corresponding to the alphabets A-Z and digits 0-9, respectively. Similarly, the CAPTCHA data may be image data, (as shown in FIG. 2A to FIG. 2C) video data or audio data.

After that, in step S430, the encryption module 114 hides corresponding encrypted data into every CAPTCHA data, wherein the encrypted data includes information corresponding to the operation. Similarly, the encrypted data may be a watermark, a digital signature, or a specific key generated by an algorithm. Please refer to FIG. 3, as shown in FIG. 3, the CAPTCHA data 300 comprises an encrypted data 310, and the encrypted data 310 further comprises second data 312 and third data 314. The second data 312 may be used to represent a corresponding operational step for the encrypted data 310, and an operation may comprise multiple operational steps. Specifically, encrypted data 310 is generated at the corresponding operational step (which is represented by second data 312). The third data 314 may represent identification information of a user of the client 120.

The CAPTCHA data with encrypted data hidden in it is transmitted to the client 120, and the client 120 may use the CAPTCHA data to perform the operation with the server 110. During the operation, the client 120 may transmit chosen CAPTCHA data to the server 110 for verification. The client 120 may transmit the corresponding CAPTCHA data or its summary information to the server 110 to verify whether data has been correctly transmitted to the server 110.

Thereafter, when the server 110 receives data sent by the client 120, the server 110 may check whether the encrypted data in the CAPTCHA data transmitted is correct, in order to ensure that the data has been transmitted correctly.

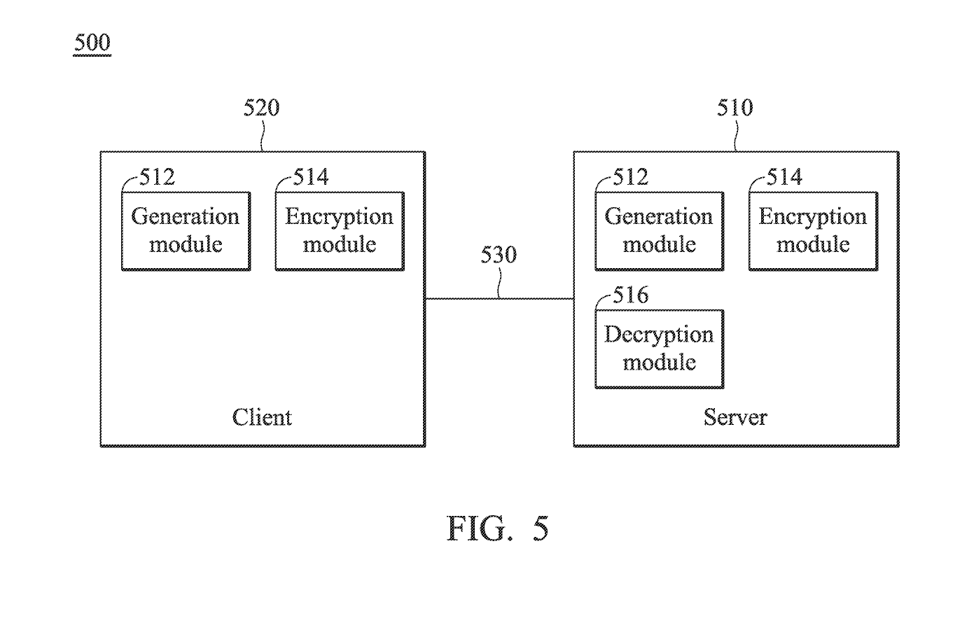

FIG. 5 is a schematic diagram illustrating another embodiment of a data management system of the invention. The data management system 500 at least comprises a server 510 and a client 520, wherein the server 510 may transmit data to the client 520 via a transmission medium, such as a network 530, for performing an operation between the server 510 and the client 520. The transmission medium may comprise, for example, and not limited to, the network 530, which may comprise wired or wireless networks, such as the INTERNET, but it is not limited thereto. In this embodiment, an operation may comprise one or more operational steps and the operational steps follow a predetermined execution flow. When the operation is performed, all of the operational steps corresponding thereto should be sequentially performed according to the predetermined execution flow.

The server 510 further comprises a generation module 512, an encryption module 514, and a decryption module 516. The generation module 512 is configured to determine a first data set according to a first data. Furthermore, the generation module 512 may determine a first data set according to one or more first data corresponding to an operation to be performed, wherein, the first data may be sensitive data corresponding to the operation, such as a user's personal identity information, account number, transaction amount, address and so on. A first data set may comprise all possible information corresponding to a first data. Then, according to a property of the first data, the generation module 512 may generate a group of CAPTCHA data corresponding to the first data set. It is to be noted that, in this embodiment, the concept of CAPTCHA is applied to provide CAPTCHA data corresponding to data required by the operation. When the first data is a numeric data composed of one or more numbers, each data segment may be one or more numbers. Therefore, according to a property of numeric data, the generation module 512 may generate a group of CAPTCHA data comprising numbers 0-9 (as shown in FIG. 2A). In another embodiment, when the first data is a character data which is composed of one or more characters, each data segment may be one or more characters. Therefore, according to a property of a character data, the generation module 512 may generate a group of CAPTCHA data comprising characters A-Z (as shown in FIG. 2B). In another embodiment, assuming the first data is an address data, the address data may comprise words or character data (such as city, district, road or street, lane, alley and so on). Therefore, according to a property of the address data, the generation module 512 may generate a group of corresponding CAPTCHA data comprising one or more characters (as shown in FIG. 2C). Note that in the embodiments described at the above, the CAPTCHA data illustrated from FIG. 2A to FIG. 2C are images or pictures (image data). However, in some embodiments, the CAPTCHA data may be in the form of video data or audio data.

After the generation module 512 generates a group of CAPTCHA data corresponding to the first data set, the encryption module 514 may hide a corresponding encrypted data into each CAPTCHA data, wherein the encrypted data includes information corresponding to the operation, such as identification information of a user or information of an operational step. In some embodiments, the encrypted data may be a watermark, a digital signature, or a specific key generated by an algorithm. Please refer to FIG. 3, wherein FIG. 3 is a schematic diagram illustrating an embodiment of a CAPTCHA data with encrypted data of the invention. As shown in FIG. 3, the CAPTCHA data 300 comprises an encrypted data 310, and the encrypted data 310 is an unseen watermark. The encrypted data 310 further comprises a second data 312 and a third data 314. For example, the second data 312 may represent a corresponding operational step for the encrypted data 310, wherein an operation may comprise multiple operational steps. Namely, encrypted data 310 is generated during a corresponding operational step indicated by the second data 312. The third data 314 may represent identification information of a user of the client 120. Specifically, by inspecting the second data 312 and the third data 314, the step for which the encrypted data 310 is generated and user may be known, and thereby, the user identity and information may be verified.

The decryption module 516 is configured to decrypt the CAPTCHA data with hidden encrypted data transmitted by the client 520. The decryption module 116 may decrypt the encrypted data (e.g. a watermark) from the CAPTCHA data transmitted by client 520, and determine whether the received data is the same as the data originally transmitted according to the content represented by the encrypted data. In some embodiments, the generation module 512 may generate summary information according to information corresponding to the operation. For example, the summary information may be a specific data structure which comprises, for example, the second data 312 and the third data 314 as described previously. In some embodiments, data transmitted by the client 520 may be the summary information corresponding to the CAPTCHA data. In this case, the decryption module 516 may decode and extract second data and third data from the summary information transmitted by client 520, and then determine whether the received data is the same as the data originally transmitted according to the content represented by the second data and the third data. The correctness of data transmitted between the server 510 and the client 520 is therefore ensured by the decryption module 516.

In other hands, the client 520 may further comprise the generation module 512, and/or the encryption module 514. It is to be understood that, the client 520 may obtain the generation module 512, and/or the encryption module 514 from a specific electronic device (such as the server 510) via a transmission medium (such as the network 530). It is to be noted that, in some embodiments, the client 520 may also obtain the generation module 512 and/or the encryption module 514 from a third party. For example, an external dongle may be provided to the client 520 via the post office or other delivery systems, or the client may obtain a smart card from a bank counter service. The main function of the generation module 512 is to determine a first data set and generate the CAPTCHA data. The main function of the encryption module 514 is to hide a corresponding encrypted data into each CAPTCHA data. The generation module 512 and encryption module 514 can be operated as described previously and thus detail of which are omitted here for brevity. The client 520 may use the CAPTCHA data or the CAPTCHA data with encrypted data hidden in it for data inputting so as to perform the operation with the server 510. During the operation, the client 520 may transmit chosen CAPTCHA data and/or responsive summary information thereof to the server 510 for verification.

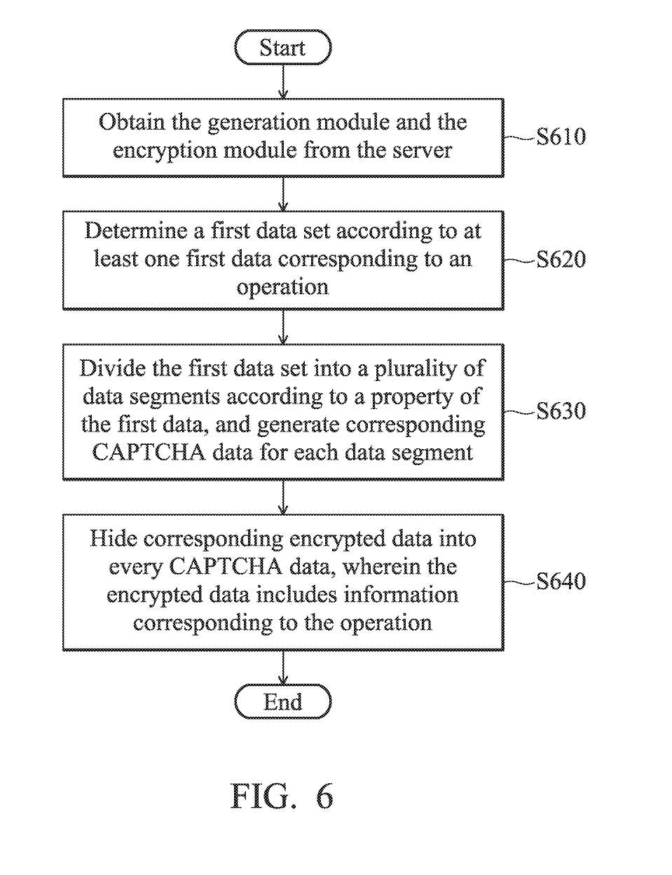

FIG. 6 is a flowchart of another embodiment of a data generation method of the invention. Please refer to FIGS. 5-6. The data generation method of the invention is suitable for use in the client 520 of the data generation system 500 for generating information required when performing an operation. The operation comprises plural operational steps with a fixed execution order. For example, an operation may comprise a first step and a second step, and the second step may be executed only after completion of the first step.

First, in step S610, the client 520 obtains/downloads the generation module 512, and the encryption module 514 from a specific electronic device (such as the server 510) via a transmission medium (such as the network 530). Similarly, in some embodiments, the client 520 may obtain the generation module 512 and/or the encryption module 514 from a third party. In step S620, the generation module 512 determines a first data set according to at least one first data corresponding to an operation. For example, when the first data comprises numeric data, the corresponding first data set may be the numbers 0-9. In another embodiment, when the first data comprises character data, the corresponding first data set may be a set of all possible characters (e.g. A-Z). Then, as shown in step S630, the generation module 512 divides the first data set into a plurality of data segments according to a property of the first data, and generates corresponding CAPTCHA data for each data segment. Similarly, when the first data comprises numeric data which is composed of one or more numbers, each data segment may be one or more numbers. When the first data comprises character data which is composed of one or more characters, each data segment may be one or more characters. For example, but not limited to, when the operation is a bank transfer operation for a net bank, the data required by the operation may comprise sensitive data such as the account number and the amount transferred, thus the client 520 may generate 10 CAPTCHA data corresponding to digits 0-9, respectively (as shown in FIG. 2A). In another embodiment, if the account number comprises a combination of the letters of the alphabet and digits, the client 520 may generate 36 CAPTCHA data corresponding to the alphabets A-Z and digits 0-9, respectively. Similarly, the CAPTCHA data may be image data, (as shown in FIG. 2A to FIG. 2C) video data or audio data.

After that, in step S640, the encryption module 514 hides corresponding encrypted data into every CAPTCHA data generated by the generation module 512, wherein the encrypted data includes information corresponding to the operation. Similarly, the encrypted data may be a watermark, a digital signature, or a specific key generated by an algorithm. Please refer to FIG. 3, as shown in FIG. 3, the CAPTCHA data 300 comprises an encrypted data 310, and the encrypted data 310 further comprises second data 312 and third data 314. The second data 312 may be used to represent a corresponding operational step for the encrypted data 310, and an operation may comprise multiple operational steps. Specifically, encrypted data 310 is generated at the corresponding operational step (which is represented by second data 312). The third data 314 may represent identification information of a user of the client 520.

The CAPTCHA data with encrypted data hidden in it is transmitted to the client 520, and the client 520 may use the CAPTCHA data to perform the operation with the server 510. During the operation, the client 520 may transmit chosen CAPTCHA data to the server 510 for verification. The client 520 may transmit the corresponding CAPTCHA data or its summary information to the server 510 to verify whether data has been correctly transmitted to the server 510.

An embodiment is described below to help explain the data processing method for the present invention in more detail, but is not limited thereto. In one embodiment, when the operation is a bank transfer operation for a net bank, the “account number” data and the “amount transferred” data will affect the outcome of the bank transfer operation. Therefore, the account numeric data and amount transferred data may be defined as sensitive data of the bank transfer operation. The corresponding data set for the “account number” data and the “amount transferred” data may be the numbers “0” to “9” and the characters “A” to “Z”. For example, the “account number” data may be “A123456” and the “amount transferred” data may be “1000”. Therefore, as described above, the numbers “0” to “9” and the characters “A” to “Z” are the possible data set. Therefore, according to the CAPTCHA data generation methods of the present invention, the generation module in the server or the client generates corresponding CAPTCHA data of numbers “0” to “9” and characters “A” to “Z” (as shown in FIG. 2A to FIG. 2B). Then, the encryption module in the server or the client hides a corresponding encrypted data such as a watermark corresponding to the operation into every CAPTCHA data. When the CAPTCHA data is generated by the server, the server may transmit the CAPTCHA data with encrypted data to the client, and the client may then process the bank transfer operation using the CAPTCHA data with encrypted data. When the CAPTCHA data is generated by the client, the client may directly process the bank transfer operation using the CAPTCHA data with encrypted data.

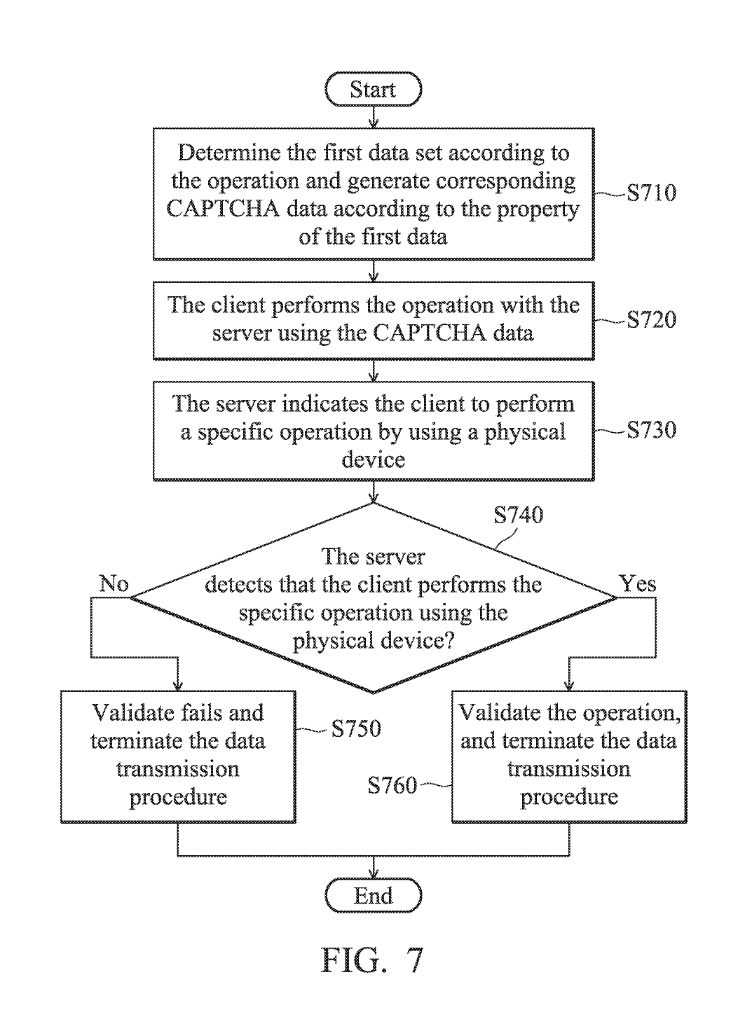

FIG. 7 is a flowchart of an embodiment of an application management method for CAPTCHA data of the invention. It is to be noted that, in this embodiment, a physical device in the client may be utilized together with the generated CAPTCHA data of the invention to improve the safety of data transmission.

First, during a data transmission procedure, in step S710, a first data set is determined according to at least one first data corresponding to an operation and a group of CAPTCHA data corresponding to the first data set are generated according to the first data. It is to be noted that, step S710 may be performed by a server or a client. When step S710 is performed by the client, the client may obtain related modules, such as the generation module and the encryption module, from a specific electronic device (such as the server 510) and then determine the first data set and generate the CAPTCHA data using the obtained modules. Similarly, in some embodiments, the client may obtain the generation module and/or the encryption module from a third party. Moreover, similarly, the first data may represent sensitive data corresponding to the operation. For example, when the operation is a bank transfer operation for a net bank, the data required by the operation may comprise sensitive data such as the account number and the amount transferred, thus the client 520 may generate 10 CAPTCHA data corresponding to digits 0-9, respectively (as shown in FIG. 2A). In another embodiment, if the account number comprises a combination of the letters of the alphabet and digits, the client 520 may generate 36 CAPTCHA data corresponding to the alphabets A-Z and digits 0-9, respectively. Similarly, the CAPTCHA data may be image data (as shown in FIG. 2A to FIG. 2C), video data or audio data.

In step S720, the client performs the operation with the server using the CAPTCHA data. It is to be noted that, in some embodiments, when the first data set and the CAPTCHA data are determined and generated by the server, the server may first transmit the CAPTCHA data to the client during the data transmission procedure. In addition, similarly, when the client performs the operation with the server using the CAPTCHA data, the client may transmit the corresponding CAPTCHA data or its summary information to the server for verification.

In step S730, before the data transmission procedure is complete, the server can optionally transmit responsive information to the client to indicate the client to perform a specific operation by using a physical device. It is to be noted that, in some embodiments, the physical device may comprise a debit card, a credit card, a memory card, a smart card or a specific device which is sensible or pluggable by the client. Note that the purpose of step S730 is to request the user at the client side to perform the specific operation using the physical device. In addition, it is to be noted that, the specific operation may be designed depend on various requirements and applications. For example, the specific operation may be defined as an operation of removing the aforementioned card or device and plugging into a reading device at the client side or a reading device that is connected to the client, such as a card reader or the like. In another embodiment, the specific operation may be defined as an operation of removing the specific device from a sensing device at the client side or a sensing device that is connected to the client such that the client can not sense the specific device. After that, the specific device may be moved to close to the sensing device at the client side or connected to the sensing device such that the client can re-sense the specific device. In another embodiment, the specific operation may be defined as an operation of adjusting at least one component of the physical device, such as change its position. It is to noted again that, the specific operation may be designed depend on various requirements and applications, and the invention is not limited to any specific operation.

Thereafter, in step S740, the server further determines whether the physical device is used by the client to perform the specific operation. When the server does not detect that the physical device is used by the client to perform the specific operation (No in step S740), in step S750, the validation fails and thus the data transmission procedure is terminated. When the server detects that the physical device is used by the client to perform the specific operation (Yes in step S740), in step S760, the validation of the operation is success and thus the data transmission procedure is terminated.

In summary, according to the data generation system and related data generation method of the invention, it is possible to generate a group of CAPTCHA data according to all possible data sets corresponding to sensitive data of a user in an operation to be performed, and then encrypt the group of CAPTCHA data with encrypted data (such as a watermark) corresponding to the operation, thereby enhancing transaction processes. By using the CAPTCHA data technique for transaction processes instead of computer-based texts, which may easily be revised by malicious programs (e.g. viruses or wooden horse programs), at both the client and the server sides, transaction processes are better protected in comparison to the transaction process using computer-based texts. Additionally, the CAPTCHA data generation technique ensures that important information is not lost or stolen during the transmission process, thereby increasing security when performing operations. Moreover, by indicating the user to perform a specific operation using a physical device at the client side, the conventional behaviors for cheating the server by sniffing and simulating the user input behavior at the client side can be avoided.

Data generation methods and data management systems thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A data generation method for CAPTCHA (Completely Automated Public Test to tell Computers and Humans Apart) data generation for a server, comprising:
determining a first data set according to at least one first data corresponding to an operation, wherein the first data represents sensitive data corresponding to the operation; and
generating a group of CAPTCHA data corresponding to the first data set according to the first data,
wherein the electronic device is a server or a client, and when the electronic device is a client, the client obtains at least a generation module from the server to determine the first data set, and generate the CAPTCHA data.

2. The data generation method as claimed in claim 1, further comprising:
hiding corresponding encrypted data into each CAPTCHA data, wherein the encrypted data includes information corresponding to the operation.

3. The data generation method as claimed in claim 2, further comprising:
generating summary information according to the information corresponding to the operation.

4. The data generation method as claimed in claim 3, wherein the operation comprises a plurality of operational steps, and the information corresponding to the operation included in the encrypted data comprises second data, wherein the second data represents a corresponding operational step for the encrypted data.

5. The data generation method as claimed in claim 4, wherein the information corresponding to the operation included in the encrypted data comprises third data, wherein the third data represents identification information of a user of the client.

6. The data generation method as claimed in claim 1, wherein the encrypted data is a watermark.

7. The data generation method as claimed in claim 1, wherein the method of generating the group of CAPTCHA data corresponding to the first data set according to the first data further comprises:
dividing the first data set into a plurality of data segments according to a property of the first data; and
generating a corresponding CAPTCHA data for each data segment.

8. The data generation method as claimed in claim 7, wherein the first data comprises numeric data, and each data segment is one or a plurality of numbers.

9. The data generation method as claimed in claim 7, wherein the first data comprises character data, and each data segment is one or a plurality of characters.

10. The data generation method as claimed in claim 1, wherein each CAPTCHA data comprises image data, video data, or audio data.

11. The data generation method as claimed in claim 1, wherein the server further transmits the group of CAPTCHA data to the client and the client further performs the operation with the server using the group of CAPTCHA data when the electronic device is the server.

12. The data generation method as claimed in claim 1, wherein the client directly transmits the group of CAPTCHA data or summary information corresponding to the group of CAPTCHA data to the server to perform the operation using the group of CAPTCHA data when the electronic device is the server.

13. A data management system for CAPTCHA (Completely Automated Public Test to tell Computers and Humans Apart) data, comprising:
an electronic device determining a first data set according to at least one first data corresponding to an operation, and generating a group of CAPTCHA data corresponding to the first data set according to the first data, wherein the first data represents sensitive data corresponding to the operation,
wherein the electronic device is a server or a client, and when the electronic device is the client, the client obtains at least one generation module from the server to determine the first data set, and generate the CAPTCHA data.

14. The data management system as claimed in claim 13, wherein the server further comprises a generation module, and the generation module is configured to determine the first data set according to the first data, and generate the group of CAPTCHA data corresponding to the first data set.

15. The data management system as claimed in claim 14, wherein the server further comprises an encryption module, and the encryption module is configured to hide corresponding encrypted data into each CAPTCHA data, wherein the encrypted data includes information corresponding to the operation.

16. The data management system as claimed in claim 15, wherein the generation module generates summary information according to the information corresponding to the operation.

17. The data management system as claimed in claim 16, wherein the operation comprises a plurality of operational steps, and the information corresponding to the operation included in the encrypted data comprises second data, wherein the second data represents a corresponding operational step for the encrypted data.

18. The data management system as claimed in claim 17, wherein the information corresponding to the operation included in the encrypted data comprises a third data, wherein the third data represents identification information of a user of the client.

19. The data management system as claimed in claim 13, wherein the encrypted data is a watermark.

20. The data management system as claimed in claim 13, wherein the generation module further divides the first data set into a plurality of data segments according to a property of the first data, and generates a corresponding CAPTCHA data for each data segment.

21. The data management system as claimed in claim 20, wherein the first data comprises numeric data, and each data segment is a number.

22. The data management system as claimed in claim 20, wherein the first data comprises character data, and each data segment is one or a plurality of characters.

23. The data management system as claimed in claim 13, wherein each CAPTCHA data comprises image data, video data, or audio data.

24. The data management system as claimed in claim 13, wherein the server further transmits the group of CAPTCHA data to the client and the client further performs the operation with the server using the group of CAPTCHA data when the electronic device is the server.

25. The data management system as claimed in claim 13, wherein the client directly transmits the group of CAPTCHA data or summary information corresponding to the group of CAPTCHA data to the server to perform the operation using the group of CAPTCHA data when the electronic device is the client.

26. A non-transitory machine-readable storage medium comprising a computer program, which, when executed, causes a device to perform a data generation method for CAPTCHA (Completely Automated Public Test to tell Computers and Humans Apart) data, comprising:
a first program code for determining a first data set according to at least one first data corresponding to an operation, wherein the first data represents sensitive data corresponding to the operation;
a second program code for generating a group of CAPTCHA data corresponding to the first data set according to the first data; and
a third program code for hiding corresponding encrypted data into each CAPTCHA data in the group of CAPTCHA data, wherein the encrypted data includes information corresponding to the operation.

27. An application management method for CAPTCHA (Completely Automated Public Test to tell Computers and Humans Apart) data, comprising:
a server or a client determining a first data set according to at least one first data corresponding to an operation and generating a group of CAPTCHA data corresponding to the first data set according to the first data, wherein the first data represents sensitive data corresponding to the operation;
during a data transmission procedure, the client performing the operation with the server using the CAPTCHA data;
before the data transmission procedure is complete, the server indicating the client to perform a specific operation by using a physical device; and
the server validating that the operation has been completed and terminating the data transmission procedure when detecting that the client performs the specific operation by using the physical device.

28. The application management method as claimed in claim 27, wherein the server further transmits the group of CAPTCHA data to the client during the data transmission procedure when the first data set and the group of CAPTCHA data are determined and generated by the server.

29. The application management method as claimed in claim 27, wherein the client further obtains at least one generation module from the server for determining the first data set and generating the group of CAPTCHA data during the data transmission procedure when the first data set and the group of CAPTCHA data are determined and generated by the client.

30. The application management method as claimed in claim 27, wherein the physical device comprises a debit card, a credit card, a memory card, a smart card or a specific device which is sensible or pluggable by the client.
